(19) United States
(12) Patent Application Publication
(10) Pub. No.: US 2017/0268694 A1
(43) Pub. Date: Sep. 21, 2017

(54) Clear Injection Valve

(71) Applicant: Angel Manuel Rivera, Fort Worth, TX (US)

(72) Inventor: Angel Manuel Rivera, Fort Worth, TX (US)

(21) Appl. No.: 15/461,351

(22) Filed: Mar. 16, 2017

Related U.S. Application Data
(60) Provisional application No. 62/309,058, filed on Mar. 16, 2016.

(51) Int. Cl. F16K 37/00; B05B 15/06; B05B 15/02

(52) U.S. Cl. CPC F16K 37/0058; B05B 15/02; B05B 15/06

(57) ABSTRACT

A clear injection valve for monitoring flow rate and clogging utilizes a flow section, an injector section, and a compression nut. The compression nut is used to fasten a chemical tubing system against the flow section. A first set of threads and a second set of threads are used to removably attach the compression nut onto a neck portion of the flow section. The flow section, which is made of transparent material, is in fluid communication with the injector section allowing fluids or other comparable matter to pass through the flow section and the injector section. In doing so, a flow channel of the flow section and an injector channel of the injector section are used. A distal opening of the injector section is used as the exit point for fluids or comparable matter. Preferably, the distal opening is connected to a plumbing system with a set of pipe-engaging threads.

The current application claims a priority to the U.S. Provisional Patent application Ser. No. 62/309,058 filed on Mar. 16, 2016.

### FIELD OF THE INVENTION

The present invention relates generally to injection valves. In particular, the present invention introduces a clear injection valve that allows easy inspection of the circulating fluid.

### BACKGROUND OF THE INVENTION

Clogging of water treatment agents within the injection valve is a major issue in water treatment facilities. The inability to visually see the clogging significantly impacts the efficiency of the water treatment plant. Therefore, the benefit of a method to promptly identify clogging is clear.

When clogged, the process of replacing injection valves can be tedious. In large scale water treatment plants, utilizing resources for maintenance activity can be time consuming and financially disadvantageous. For increased efficiency, the number of malfunctioning injection valves need to be minimized.

Accuracy is vital in water purification systems. If injector valves are malfunctioning, the dosage of chemicals emitted to the water system is not consistent. The inconsistency can lead to imbalances in the property of water. Thus, a method to ensure proper discharge of chemicals is required.

The objective of the present invention is to address the aforementioned issues. The present invention introduces a clear injection valve that can be used to observe the flow through the valve. More specifically, the present invention introduces a chemical injection valve that can be used to inject acid, liquid bleach or any other comparable chemical. Preferably, the injector is made of clear polyethylene enabling a clear view of the chemical flowing through the injector valve and the ability to verify flow and clogging. Thus, by utilizing the present invention, any potential clogging in the injection valve can be prevented.

### BRIEF DESCRIPTION OF THE DRAWINGS

FIG. 1 is a front view of the present invention.

FIG. 2 is another front view of the present invention, wherein the internal components are also illustrated.

FIG. 3A is a cross-sectional front view of the present invention.

FIG. 3B is an exploded cross-sectional view of the present invention.

FIG. 4 is a front view of the flow section.

FIG. 5 is a front view of the injector section.

FIG. 6 is a perspective view of the compression nut.

### DETAIL DESCRIPTIONS OF THE INVENTION

All illustrations of the drawings are for the purpose of describing selected versions of the present invention and are not intended to limit the scope of the present invention.

The present invention introduces a clear injection valve that can be used to inject varying chemicals in water treatment processes. More specifically, the present invention introduces a solution for clogging and provides a method to verify flow within an injection valve.

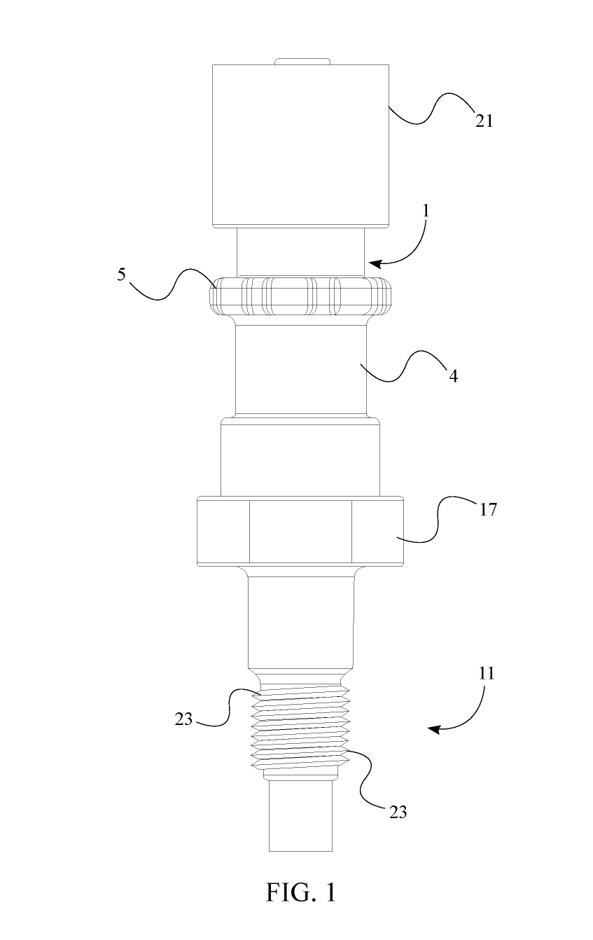

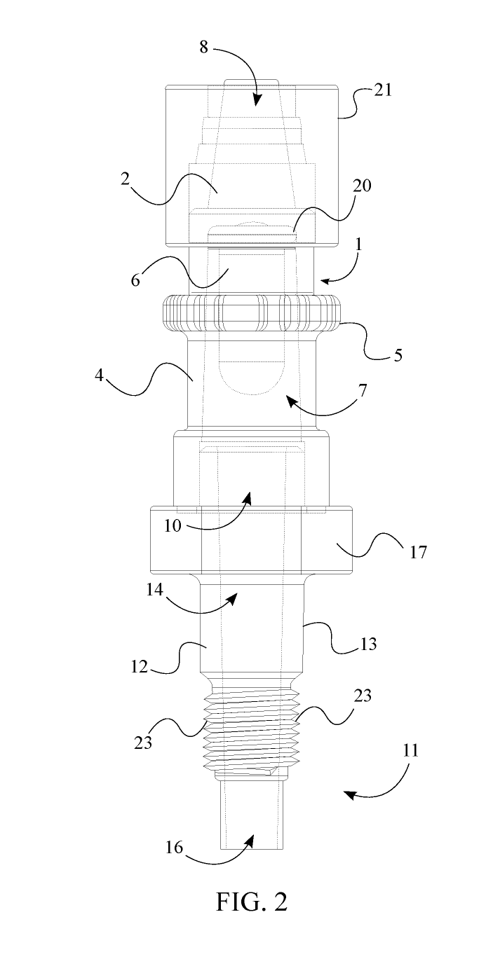

As illustrated in FIG. 1 and FIG. 2, the present invention comprises a flow section 1, an injector section 11, and a compression nut 21. The flow section 1 is connected to the chemical tubing system providing the chemicals. In the preferred embodiment, the flow section 1 is connected to a chemical tubing system providing chemicals to a water treatment plan. The compression nut 21 is used to secure the chemical tubing system with the flow section 1. Upon securing, the chemicals are released to an intended medium via the injector section 11. The effective design allows the user to monitor the flow through the present invention, and address any regularities.

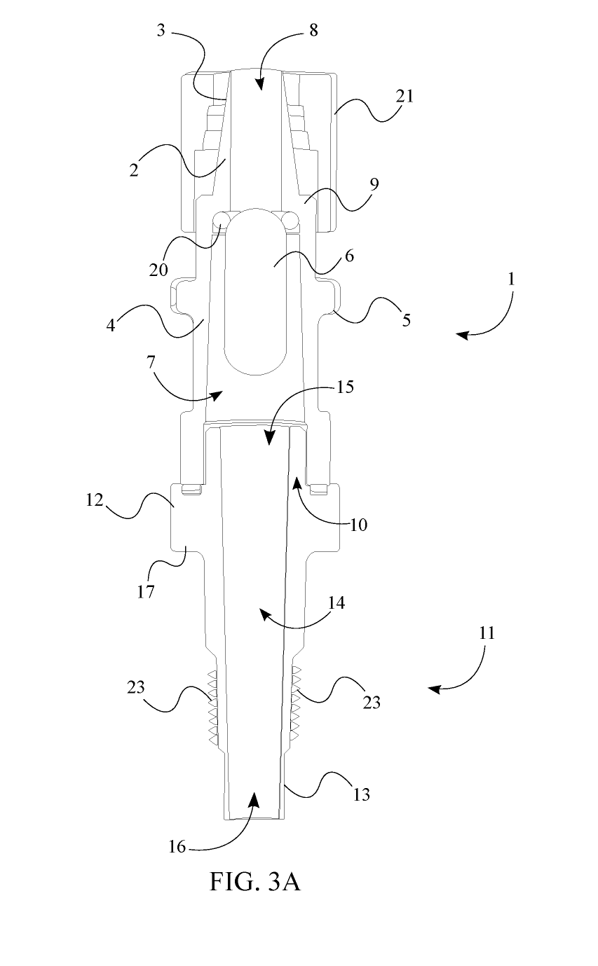

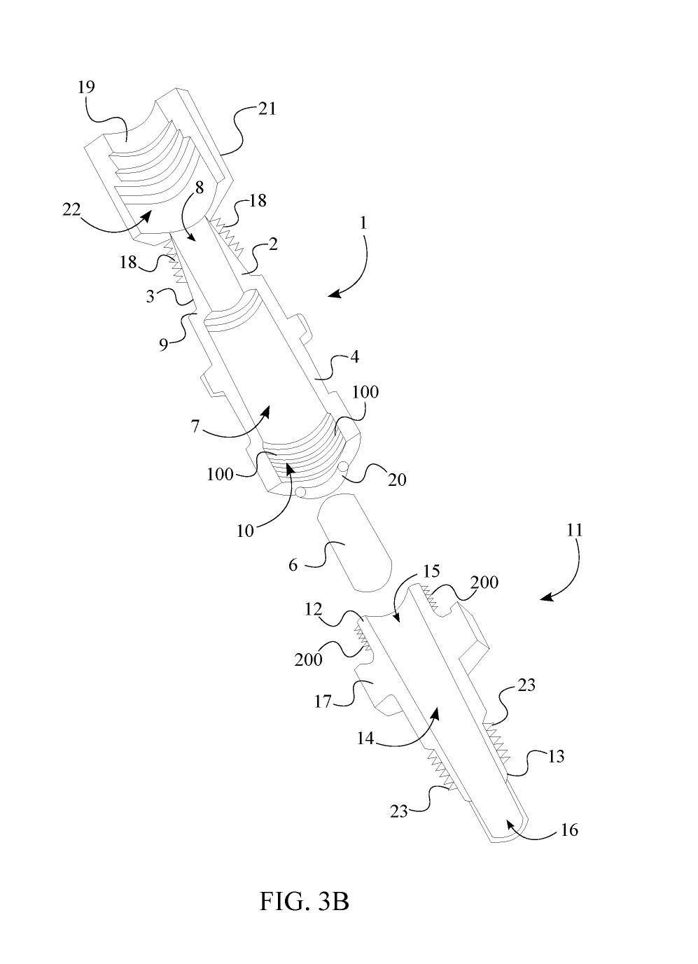

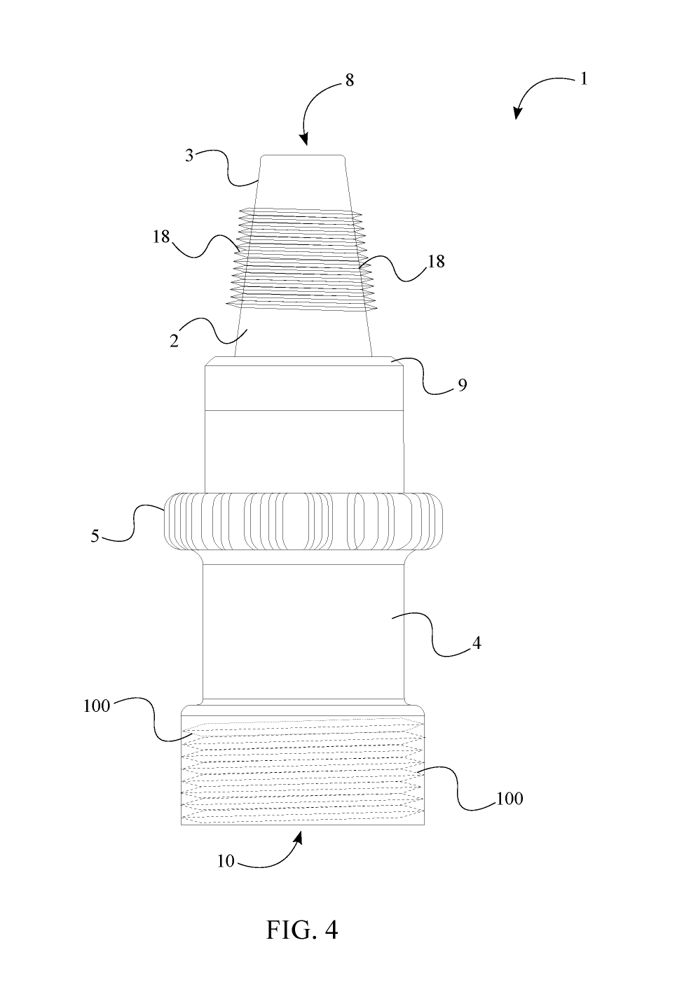

As seen in FIG. 3A, FIG. 3B, and FIG. 4, the flow section 1 comprises a neck portion 2, a body portion 4, a flow indicator 6, and a flow channel 7. The neck portion 2 is connected to the body portion 4 so that the neck portion 2 is concentrically aligned with the body portion 4. The flow channel 7 axially traverses through the neck portion 2 and the body portion 4 creating a path for the fluids to pass through the flow section 1. The flow section 1 is manufactured from a transparent material so that the flow of the fluid can be monitored with the use of the flow indicator 6. Additionally, any clogging that occurs within the present invention can be promptly addressed so that the efficiency of the water treatment plant or other comparable application remains unchanged. Material that is used to manufacture the flow section 1 can be, but is not limited to, acrylics, butyrate, Lexan, Trogamid, and/or polyethylene terephthalate. However, in another embodiment of the present invention, the flow section 1 can be manufactured from metallic materials with an appropriately positioned clear window to monitor the flow with the flow indicator 6.

In the preferred embodiment of the present invention, the flow section 1 further comprises an inlet 8, a collar 9, and an outlet 10 as illustrated in FIG. 3B. The flow channel 7 extends from the inlet 8 to the outlet 10 so that the fluids injected at the inlet 8, exits the flow channel 7 at the outlet 10. The collar 9 is positioned in between the inlet 8 and the outlet 10 and separates the neck portion 2 from the body portion 4. In particular, the neck portion 2 is connected to the body portion 4 at the collar 9. As mentioned before, the chemical tubing system is attached at the flow section 1. To appropriately receive the chemical tubing system, an external surface 3 of the neck portion 2 is tapered outwards from the inlet 8 to the collar 9 creating a conical shape for the neck portion 2.

As discussed before, the flow indicator 6 is used to monitor the flow rate through the present invention. In doing so, the flow indicator 6 is positioned within the flow channel 7 and positioned in between the collar 9 and the outlet 10. The flow channel 7 is tapered outwards from the collar 9 towards the outlet 10 so that the flow indicator 6 can be effectively positioned within the body portion 4. The flow indicator 6 can vary in different embodiments of the present invention. As an example, in another embodiment of the present invention, the flow indicator 6 can be at least two flow indicating bearings that are positioned within the flow channel 7. In such instances, the at least two flow indicating bearings can be of different colors and produced from polyethylene or other comparable materials.

The present invention further comprises an O-ring 20 for preventing back pressure. The O-ring 20 is positioned within the flow channel 7 and is peripherally connected to the collar 9 opposite to the neck portion 2. Preferably, the O-ring 20 is composed of an elastomeric chemical resistant material. The flow indicator 6 is positioned adjacent to the O-ring 20 opposite to the neck portion 2.

Upon passing the flow section 1, fluids, gasses or other comparable matter enter the injector section 11 prior to entering the plumbing system. The injector section 11 comprises an injector body 12 and an injector channel 14. The injector channel 14, which axially traverses through the injector body 12, is in fluid communication with the flow channel 7 to pass fluids or other comparable matter from the flow section 1 to the injector section 11. For effective flow, the flow channel 7 is concentrically aligned with the injector channel 14.

As illustrated in FIG. 3B, the injector section 11 further comprises a proximal opening 15 and a distal opening 16, wherein the injector channel 14 extends from the proximal opening 15 to the distal opening 16. The proximal opening 15 is positioned adjacent to the outlet 10, resulting in the outlet 10 being in fluid communication with the proximal opening 15. In the resulting position, the distal opening 16 is oriented towards the plumbing system or other comparable target. The injector channel 14 is tapered from the proximal opening 15 to the distal opening 16 in the preferred embodiment of the present invention. When the proximal opening 15 is positioned adjacent the outlet 10, a stopping band 17 of the injector section 11 is pressed against the body portion 4. To do so, the stopping band 17 is peripherally connected adjacent the proximal opening 15.

The preferred embodiment of the present invention utilizes a set of internal threads 100 and a set of external threads 200 to attach the flow section 1 to the injector section 11. As seen in FIG. 3B, the set of internal threads 100 is internally distributed within the flow channel 7 adjacent to the outlet 10. On the other hand, the set of external threads 200 is externally distributed along the injector body 12 adjacent to the proximal opening 15. Different attachment mechanisms can be used in alternative embodiments of the present invention to attach the flow section 1 to the injector section 11.

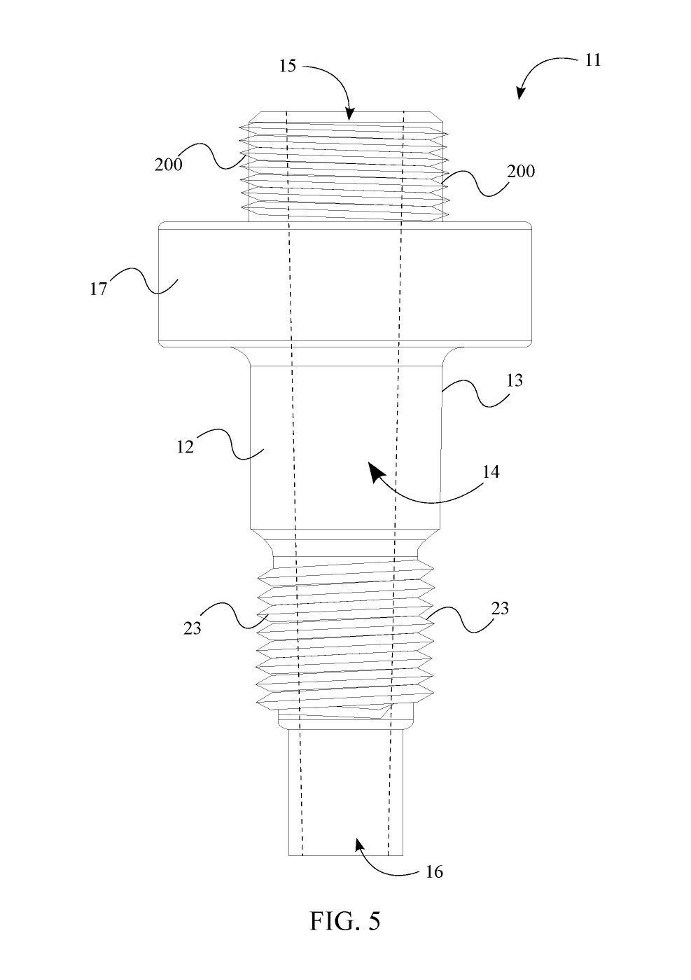

To attach the injector section 11 to the plumbing system, the present invention utilizes a set of pipe-engaging threads 23 as illustrated in FIG. 5. The set of pipe-engaging threads 23, which can vary in different embodiments of the present invention, is peripherally distributed along an external surface 13 of the injector body 12 adjacent to the distal opening 16. Preferably, the set of pipe-engaging threads 23 is a ¼-inch threading.

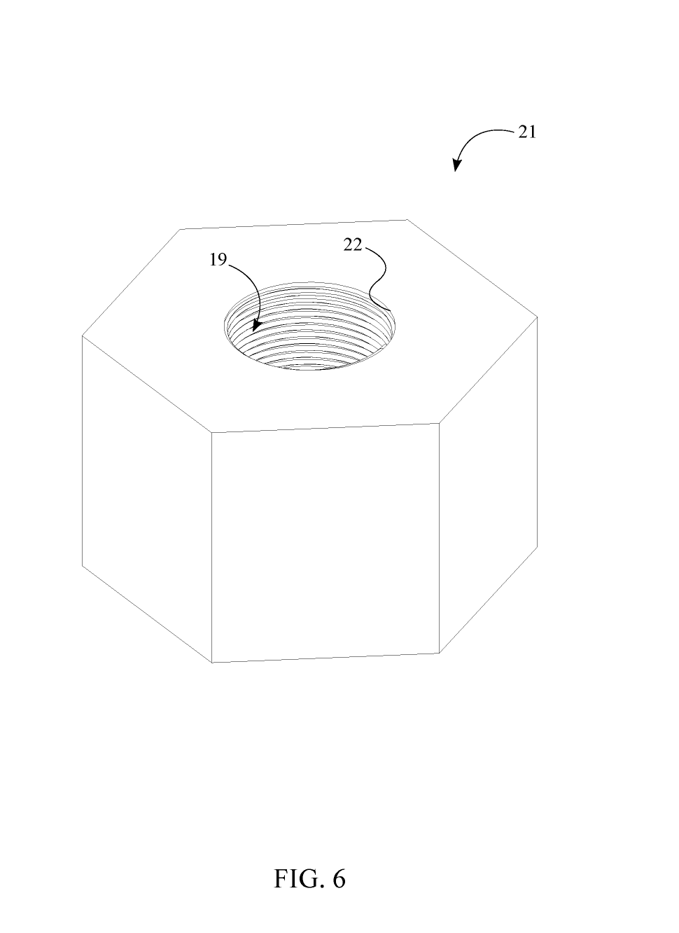

The compression nut 21, which is illustrated in FIG. 6, is used to secure the chemical tubing system against the flow section 1. To do so, the compression nut 21 is removably attached to the neck portion 2, wherein the neck portion 2 is concealed by the compression nut 21. The present invention utilizes a first set of threads 18 and a second set of threads 19 to removably attach the compression nut 21 to the flow section 1. The first set of threads 18 is peripherally distributed along an external surface 3 of the neck portion 2. In the preferred embodiment of the present invention, the first set of threads 18 is a ⅜-inch threading. However, the first set of threads 18 can vary per the application. To correspond with the first set of threads 18, the second set of threads 19 is distributed along an inner lateral surface 22 of the compression nut 21. When the compression nut 21 is screwed onto the neck portion 2, the first set of threads 18 is engaged with the second set of threads 19.

To aid with the process of securing the chemical tubing system, the body portion 4 further comprises a gripping ring 5. The gripping ring 5 is peripherally connected to the body portion 4 as seen in FIG. 4. For user convenience, the gripping collar 9 is positioned in between the collar 9 and the outlet 10.

When the present invention is being used, the chemical tubing system is connected to the flow section 1. In doing so, a tube is positioned over the external surface 3 of the neck portion 2. When appropriately positioned, the compression nut 21 is fastened onto the neck portion 2 with the use of the first set of threads 18 and the second set of threads 19. The gripping ring 5 is utilized in the fastening process. When connected, fluids or other comparable matter can flow through the flow section, the injector section 11, and into the intended target. In a water treatment plant, the intended target is the plumbing system. To do so, the injector section 11 is attached to the intended target with the set of pipe-engaging threads 23. When a fluid is flowing through the present invention, the flow and any potential clogging can be monitored since the flow section 1 is transparent.

Although the invention has been explained in relation to its preferred embodiment, it is to be understood that many other possible modifications and variations can be made without departing from the spirit and scope of the invention as hereinafter claimed.

What is claimed is:

1. A clear injection valve comprises:
a flow section;
an injector section;
a compression nut;
the flow section comprises a neck portion, a body portion, a flow indicator, and a flow channel;
the injector section comprises an injector body and an injector channel;
the neck portion being concentrically connected adjacent to the body portion;
the flow channel axially traversing through the neck portion and the body portion;
the injector channel axially traversing through the injector body;
the flow channel and the injector channel being concentrically aligned to each other;
the flow channel being in fluid communication with the injector channel;
the flow indicator being positioned within the flow channel; and
the compression nut being removably attached to the neck portion, wherein the neck portion is concealed by the compression nut.

2. The clear injection valve as claimed in claim 1, wherein the flow section is manufactured from a transparent material.

3. The clear injection valve as claimed in claim 1 further comprises:
the flow section further comprises an inlet, a collar, and an outlet;
the flow channel extending from the inlet to the outlet;
the neck portion being connected to the body portion at the collar;
an external surface of the neck portion being tapered outwards from the inlet to the collar;
the flow indicator being positioned in between the collar and the outlet; and
the flow channel being tapered outwards from the collar to the outlet.

4. The clear injection valve as claimed in claim 3 further comprises:
an O-ring;
the O-ring being positioned within the flow channel;
the O-ring being peripherally connected at the collar opposite to the neck portion; and
the flow indicator being positioned adjacent the O-ring opposite to the neck portion.

5. The clear injection valve as claimed in claim 1 further comprises:
the injector section comprises a proximal opening and a distal opening;
the injector channel extending from the proximal opening to the distal opening;
the proximal opening being positioned adjacent to an outlet of the flow section; and
the outlet being in fluid communication with the proximal opening.

6. The clear injection valve as claimed in claim 5, wherein the injector channel is tapered from the proximal opening to the distal opening.

7. The clear injection valve as claimed in claim 5 further comprises:
the injector section further comprises a stopping band;
the stopping band being peripherally connected adjacent to the proximal opening; and
the stopping band being pressed against the body portion.

8. The clear injection valve as claimed in claim 1 further comprises:
a set of internal threads;
a set of external threads;
the set of internal threads being internally distributed within the flow channel adjacent to an outlet of the flow section; and
the set of external threads being externally distributed along the injector body adjacent to a proximal opening of the injector section.

9. The clear injection valve as claimed in claim 1 further comprises:
a first set of threads;
a second set of threads;
the first set of threads being peripherally distributed along an external surface of the neck portion;
the second set of threads being distributed along an inner lateral surface of the compression nut; and
the first set of threads being engaged with the second set of threads.

10. The clear injection valve as claimed in claim 1 further comprises:
a set of pipe-engaging threads; and
the set of pipe-engaging threads being peripherally distributed along an external surface of the injector body adjacent to the distal opening.

11. The clear injection valve as claimed in claim 1 further comprises:
the body portion comprises a gripping ring;
the gripping ring being peripherally connected to the body portion; and
the gripping ring being positioned in between the collar and the outlet.

12. The clear injection valve as claimed in claim 1, wherein the flow indicator is at least a pair of bearings.
